(19) United States
(12) Patent Application Publication
(10) Pub. No.: US 2013/0238311 A1
(43) Pub. Date: Sep. 12, 2013

(54) Method and Implementation of Providing a Communication User Terminal with Adapting Language Translation

(71) Applicant: Sierra JY Lou, Fremont, CA (US)

(72) Inventor: Sierra JY Lou, Fremont, CA (US)

(21) Appl. No.: 13/867,080

(22) Filed: Apr. 21, 2013

(51) Int. Cl. G06F 17/28

(52) U.S. Cl. CPC G06F 17/28
USPC 704/3

(57) ABSTRACT

The method and implementation provides a communication user terminal with adapting language translation for language identification and translation for multilingual multimedia communication without language barrier.

### BACKGROUND OF THE PRESENT INVENTION

1. Field of Invention

The present invention relates to the field of communication, and more particularly to a method and implementation of providing a communication user terminal with adapting language translation for language identification and translation for multilingual multimedia communication without language barrier.

2. Description of Related Arts

In the current communication field, with the growing popularity of communication user terminals such as notebook computers, tablet computers, cell phones and smart phones having built-in language translation utilities for translating a text or speech in one language to another language, people are using the language translation utility as a language translation tool to translate a text or speech in their preferred language to another language for their personal reference. However, none of these communication user terminals for a user have the language identification and language translation ability in translating a received text or speech from another communication user terminal's user's language to the user's preferred language for the purpose of communicating without language barrier.

Whereas, the presented invention of communication user terminal with adapting language translation, in addition to providing normal text, voice and video of multimedia communication for a user, has language stamping, language processing, language identifying and language translating capabilities that provide automatic language translation between two different-language-speaking users to communicate through a communication network.

### SUMMARY OF THE PRESENT INVENTION

An object of this invention is to provide a method and implementation for a communication user terminal with adapting language translation.

The series of solutions of the present invention are:

A real time voice communication user terminal with adapting language translation for a user, comprising:

choosing user's designated language that comes with a correlating language-stamp as user's language-stamp for user's language identifier and adding the user's language-stamp to the beginning of outgoing digital audio stream of user's outgoing voice before the outgoing digital audio stream is transmitted to a connected communication network, wherein a specific language correlates to a specific language-stamp, wherein the language-stamp comprises a digital audio stream of an audio clip, wherein the frequency of the audio is within the audio frequency band;

recognizing whether incoming digital audio stream contains the language-stamp, wherein when the beginning of the incoming digital audio stream contains the language-stamp, the real time voice communication user terminal identifies the language-stamp as a recognized language identifier of a recognized language for the incoming digital audio stream; and

translating from speech portion of the incoming digital audio stream in the recognized language to the speech in the user's designated language when the recognized language identifier is not the same as the user's language identifier.

Accordingly, the real time voice communication user terminal provides one-to-multiple real time voice communication with a plurality of communication user terminals via the communication network, wherein the real time voice communication user terminal adds the user's language-stamp to the beginning of the outgoing digital audio stream before the outgoing digital audio stream is transmitted to each of the connected communication user terminals via the communication network, wherein each of the communication user terminals is selected from the group consisting of the real time voice communication user terminal and another communication user terminal for real time voice communication.

Accordingly, the real time voice communication user terminal adds a digital audio stream of a user's pre-selected voice clip to the beginning of the outgoing digital audio stream and right after the user's language-stamp before the outgoing digital audio stream is transmitted to each of the connected communication user terminals via the communication network when the user's pre-selected voice clip is pre-selected by the user, wherein the frequency of the voice clip is within the telephony voice band.

Accordingly, the user's designated language is selected from the group consisting of user's preferred language, user's preset language and the real time voice communication user terminal's system currently selected language.

Accordingly, the communication network is selected from the group consisting of mobile communication network, telecommunication network, wireless telecommunication network, Internet, local area network, and wireless local area network.

A multimedia communication user terminal with adapting language translation for a user, comprising:

choosing user's designated language that comes with a correlating language identifier as user's language identifier and encoding the user's language identifier into an outgoing protocol session message before the outgoing protocol session message is transmitted to a linked multimedia communication network;

determining whether an incoming protocol session message contains the language identifier, wherein when the incoming protocol session message contains the language identifier, the multimedia communication user terminal identifies the language-stamp as a recognized language identifier of a recognized language for the following incoming session multimedia; and

translating from speech portion of digital audio stream of the incoming session multimedia in the recognized language to the speech in the user's designated language when the recognized language identifier is not the same as the user's language identifier, translating from speech portion of voice message of the incoming session multimedia in the recognized language to the speech in the user's designated language when the recognized language identifier is not the same as the user's language identifier, and translating from text data portion of text message of the incoming session multimedia in the recognized language to the text data in the user's designated language when the recognized language identifier is not the same as the user's language identifier.

Accordingly, wherein the multimedia communication user terminal provides one-to-multiple multimedia communication with a plurality of communication user terminals via the multimedia communication network, wherein the multimedia communication user terminal encodes the user's language identifier into the outgoing protocol session message before the outgoing protocol session message is transmitted to each of the linked communication user terminals via the multimedia communication network, wherein each of the communication user terminals is selected from the group consisting of the multimedia communication user terminal and another communication user terminal for multimedia communication.

Accordingly, wherein the user's designated language is selected from the group consisting of user's preferred language, user's preset language and the multimedia communication user terminal of system currently selected language, wherein the language identifier is selected from the group consisting of a letter, letters, a number, numbers, ASCII code, and ASCII codes.

Accordingly, wherein the protocol session message is selected from the group consisting of telephony signaling protocols message, IP telephony protocols session message, and data communication control protocols message, wherein the session multimedia is selected from the group consisting of digital audio stream of voice, voice message, and text message.

Accordingly, wherein the multimedia communication network is selected from the group consisting of mobile communication network, telecommunication network, wireless telecommunication network, Internet, local area network, and wireless local area network.

A method for implementing real time voice communication user terminal with adapting language translation for a user, comprising the steps of:

(a) choosing user's designated language that comes with a correlating language-stamp as user's language-stamp for user's language identifier;

(b) adding the user's language-stamp to the beginning of outgoing digital audio stream of user's outgoing voice;

(c) transmitting the outgoing digital audio stream with the user's language-stamp added at the beginning to a connected communication network;

(d) recognizing the language-stamp from incoming digital audio stream;

(e) when the beginning of the incoming digital audio stream contains the language-stamp, identifying the language-stamp as a recognized language identifier of a recognized language for the incoming digital audio stream; and

(f) when the recognized language identifier is not the same as the user's language identifier, translating from speech portion of the incoming digital audio stream in the recognized language to the speech in the user's designated language.

Accordingly, wherein, in step (c), when the real time voice communication user terminal connects with a plurality of communication user terminals via the communication network, transmitting the outgoing digital audio stream with the user's language-stamp added at the beginning to each of the connected communication user terminals via the communication network, wherein each of the communication user terminals is selected from the group consisting of the real time voice communication user terminal and another communication user terminal for real time voice communication.

Accordingly, wherein, in step (b), adding a digital audio stream of a user's pre-selected voice clip to the beginning of the outgoing digital audio stream and right after the user's language-stamp when the user's pre-selected voice clip is pre-selected by the user, wherein the frequency of the voice clip is within the telephony voice band.

Accordingly, wherein, in step (a), a specific language correlates to a specific language-stamp, wherein the language-stamp comprises a digital audio stream of an audio clip, wherein the frequency of the audio is within the audio frequency band, wherein the user's designated language is selected from the group consisting of user's preferred language, user's preset language and the user terminal of system currently selected language.

Accordingly, wherein, in step (c), the communication network is selected from the group consisting of mobile communication network, telecommunication network, wireless telecommunication network, Internet, local area network, and wireless local area network.

A method for implementing multimedia communication user terminal with adapting language translation for a user, comprising the steps of:

(a) choosing user's designated language that comes with a correlating language identifier as user's language identifier;

(b) encoding the user's language identifier into an outgoing protocol session message;

(c) transmitting the outgoing protocol session message with the user's language identifier encoded to a linked multimedia communication network;

(d) determining the language identifier from an incoming protocol session message;

(e) when the incoming session message contains the language identifier, identifying the language identifier as a recognized language identifier of a recognized language for the following incoming session multimedia;

(f) when the recognized language identifier is not the same as the user's language identifier, translating from speech portion of audio stream of the incoming session multimedia in the recognized language to the speech in the user's designated language;

(g) when the recognized language identifier is not the same as the user's language identifier, translating from speech portion of voice message of the incoming session multimedia in the recognized language to the speech portion in the user's designated language; and

(h) when the recognized language identifier is not the same as the user's language identifier, translating from text data portion of text message of the incoming session multimedia in the recognized language to the text data portion in the user's designated language.

Accordingly, wherein, in step (c), when the multimedia communication user terminal communicates with a plurality of communication user terminals via the multimedia communication network, transmitting the outgoing protocol session message with the user's language identifier encoded to each of the linked multimedia communication user terminals via the multimedia communication network, wherein each of the communication user terminals is selected from the group consisting of the multimedia communication user terminal and another communication user terminal for multimedia communication.

Accordingly, wherein, in step (a), the language identifier is selected from the group consisting of a letter, letters, a number, numbers, ASCII code, and ASCII codes, wherein the user's designated language is selected from the group consisting of user's preferred language, user's preset language and the multimedia communication user terminal of system currently selected language.

Accordingly, wherein, in step (b), the protocol session message is selected from the group consisting of telephony signaling protocols message, IP telephony protocols session message, and data communication control protocols message, wherein the session multimedia is selected from the group consisting of digital audio stream of voice, voice message, and text message.

Accordingly, wherein, in step (c), wherein the multimedia communication network is selected from the group consisting of mobile communication network, telecommunication network, wireless telecommunication network, Internet, local area network, and wireless local area network.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an architectural diagram illustrating the real time voice communication user terminal with adapting language translation linking with a communication network to communicate with one or more communication user terminals.

FIG. 2 is an architectural diagram illustrating the multimedia communication user terminal with adapting language translation linking with a multimedia communication network to communicate with one or more communication user terminals.

FIG. 3 is a perspective view of the language-stamp table illustrating a specific language correlating to a specific language-stamp.

FIG. 4 is a diagram illustrating the process of the real time voice communication user terminal of the embodiment of the present invention.

FIG. 5 is a diagram illustrating the process of the real time voice communication user terminal of the embodiment of the present invention.

FIG. 6 is a diagram illustrating the process of the real time voice communication user terminal of the embodiment of the present invention.

FIG. 7 is a perspective view of the language identifier table illustrating a specific language correlating to a specific language identifier.

FIG. 8 is a diagram illustrating the process of the multimedia communication user terminal of the embodiment of the present invention.

FIG. 9 is a diagram illustrating the process of the multimedia communication user terminal of the embodiment of the present invention.

FIG. 10 is a diagram illustrating the process of the multimedia communication user terminal of the embodiment of the present invention.

FIG. 11 is a diagram illustrating the process of the multimedia communication user terminal of the embodiment of the present invention.

FIG. 12 is a diagram illustrating the process of the multimedia communication user terminal of the embodiment of the present invention.

FIG. 13 is a diagram illustrating the process of the real time voice communication user terminal of the embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art.

The general principles defined in the following description would be applied to other embodiments, alternatives, modifications, equivalents, and applications without departing from the spirit and scope of the present invention.

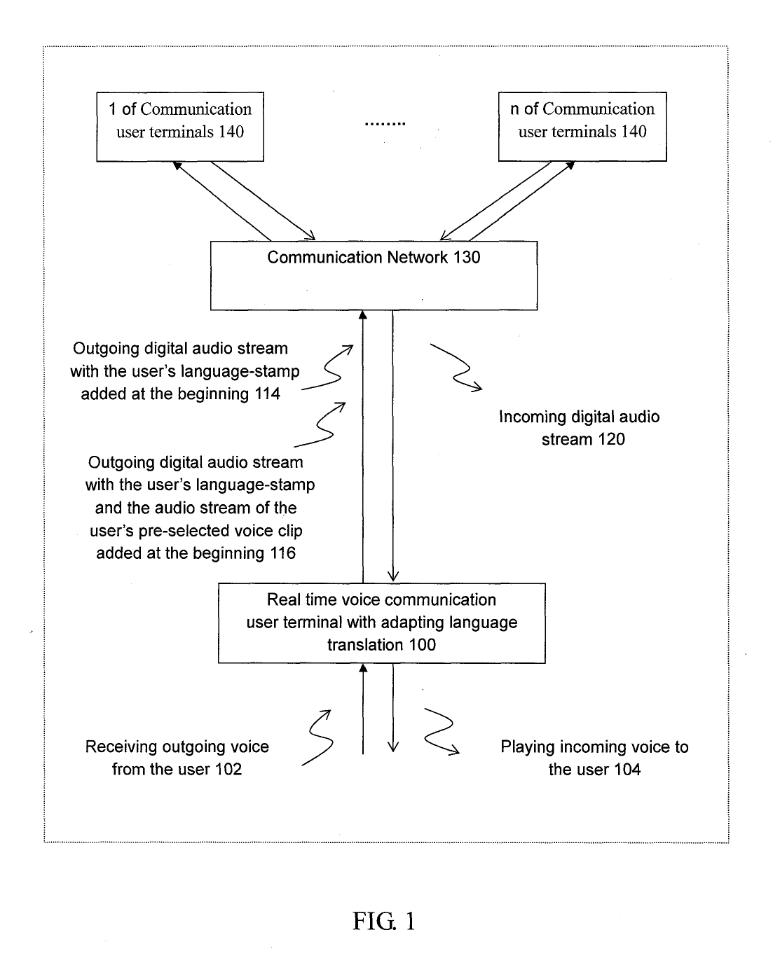

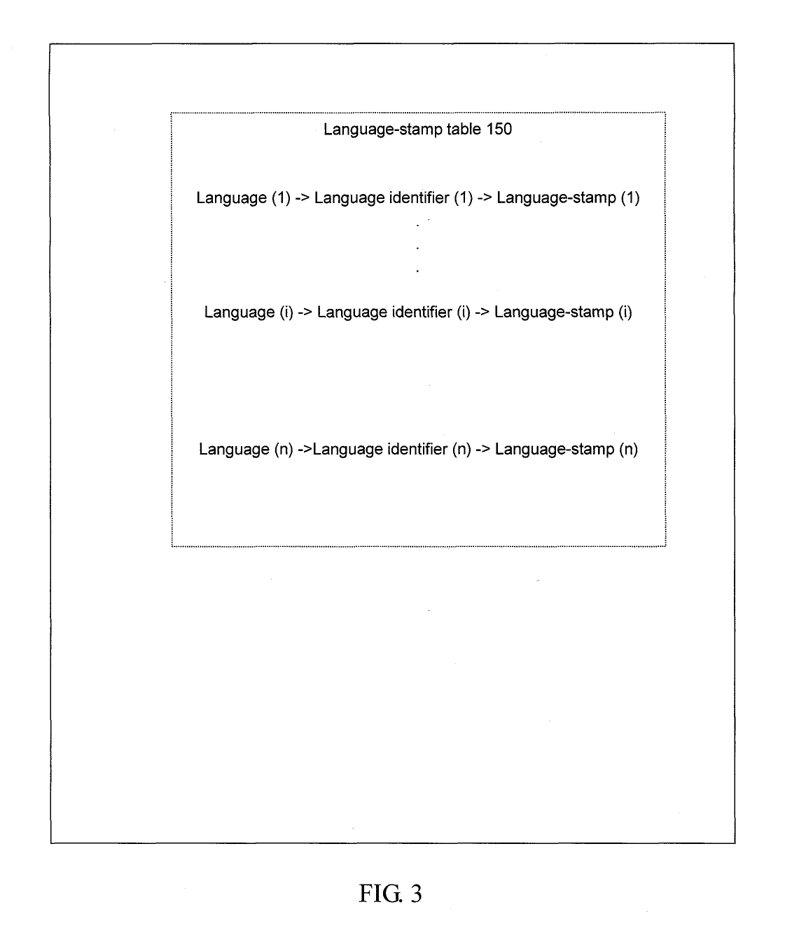

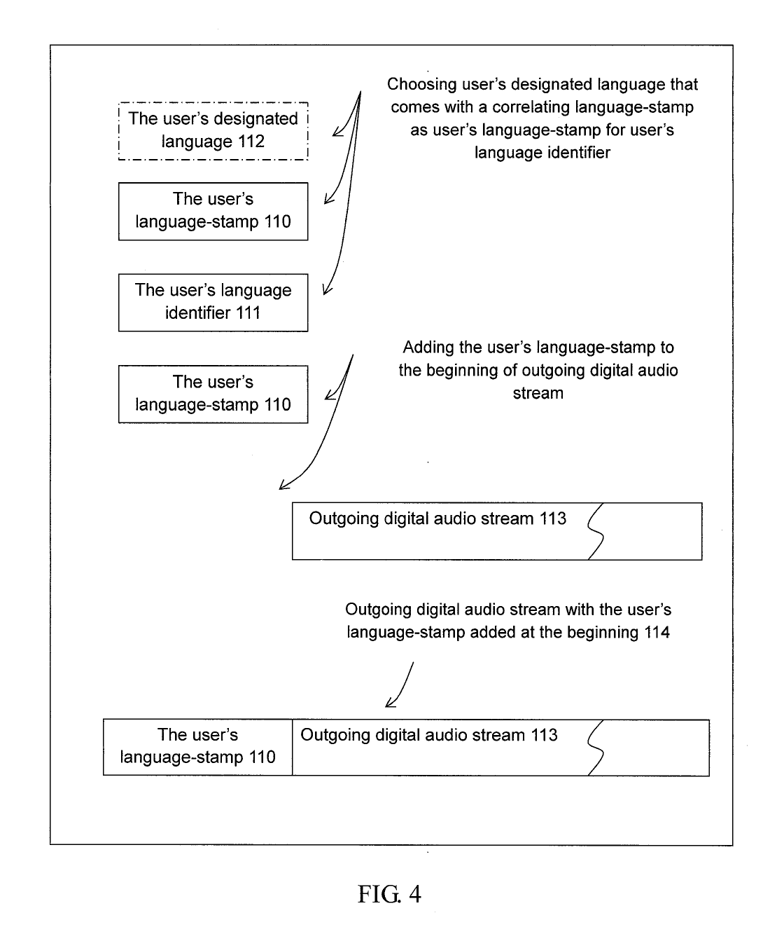

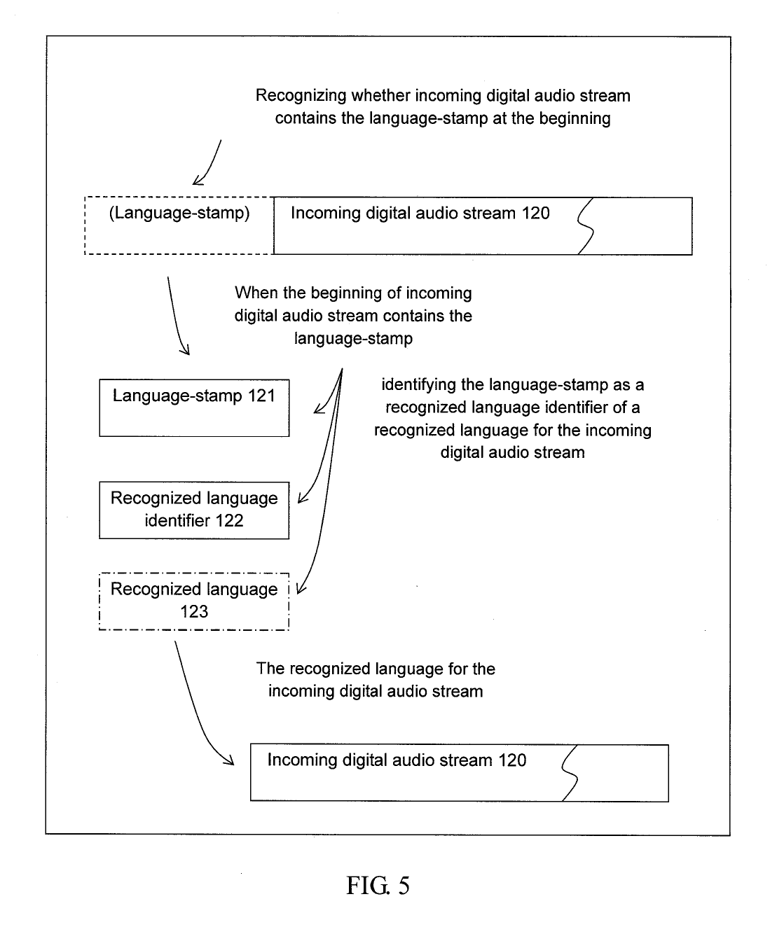

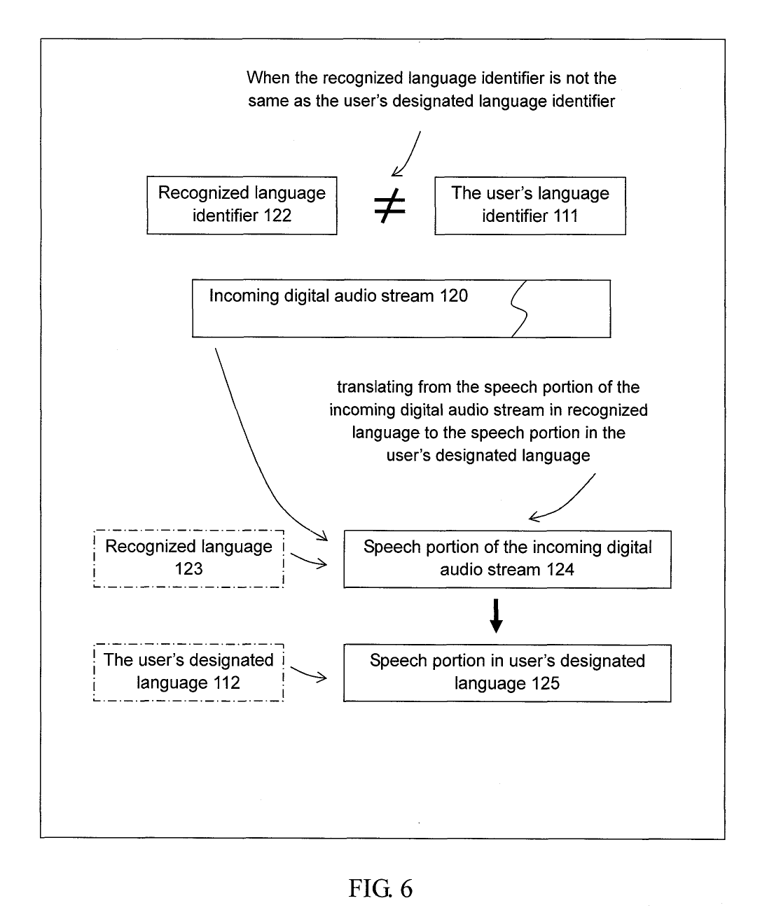

Referring to FIG. 1 of the drawings, an architectural diagram illustrating the real time voice communication user terminal with adapting language translation linking with a communication network to communicate with one or more communication user terminals, FIG. 3 of the drawings, a perspective view of the language-stamp table illustrating a specific language correlating to a specific language-stamp, and FIG. 4 to FIG. 6 of the drawings, the diagram illustrating of the process of the real time voice communication user terminal of the embodiment of the present invention, the real time voice communication user terminal with adapting language translation 100 chooses user's designated language 112 that comes with a correlating language-stamp as user's language-stamp 110 for user's language identifier 111 from the language-stamp table 150, adds the user's language-stamp 110 to the beginning of the outgoing digital audio stream 113 of user's outgoing voice 102 before the outgoing digital audio stream 113 is transmitted to a connected communication network 130, recognizes whether the incoming digital audio stream 120 contains the language-stamp, identifies the language-stamp 121 as the recognized language identifier 122 of the recognized language 123 for the incoming digital audio stream 120 when the beginning of the incoming digital audio stream 120 contains the language-stamp 121, and translates from speech portion of the incoming digital audio stream 124 in the recognized language 123 to the speech in the user's designated language 125 when the recognized language identifier 122 is not the same as the user's language identifier 111, wherein a specific language correlates to a specific language-stamp, wherein the language-stamp comprises a digital audio stream of an audio clip such as a specific single- or multi-frequency tone clip, wherein the frequency of the audio is within the audio frequency band.

Accordingly, the real time voice communication user terminal 100 provides one-to-multiple real time voice communication with a plurality of communication user terminals 140 via the communication network 130, wherein the real time voice communication user terminal 100 adds the user's language-stamp 110 to the beginning of the outgoing digital audio stream 113 of before the outgoing digital audio stream 113 is transmitted to each of the connected communication user terminals 140 via the communication network 130, wherein each of the communication user terminals 140 is selected from the group consisting of the real time voice communication user terminal 100 and another communication user terminal for voice communication, wherein, the real time voice communication user terminal 100 and each of the communication user terminals 140 is a cell phone, a smart phone, or a computer with real time voice communication features supported.

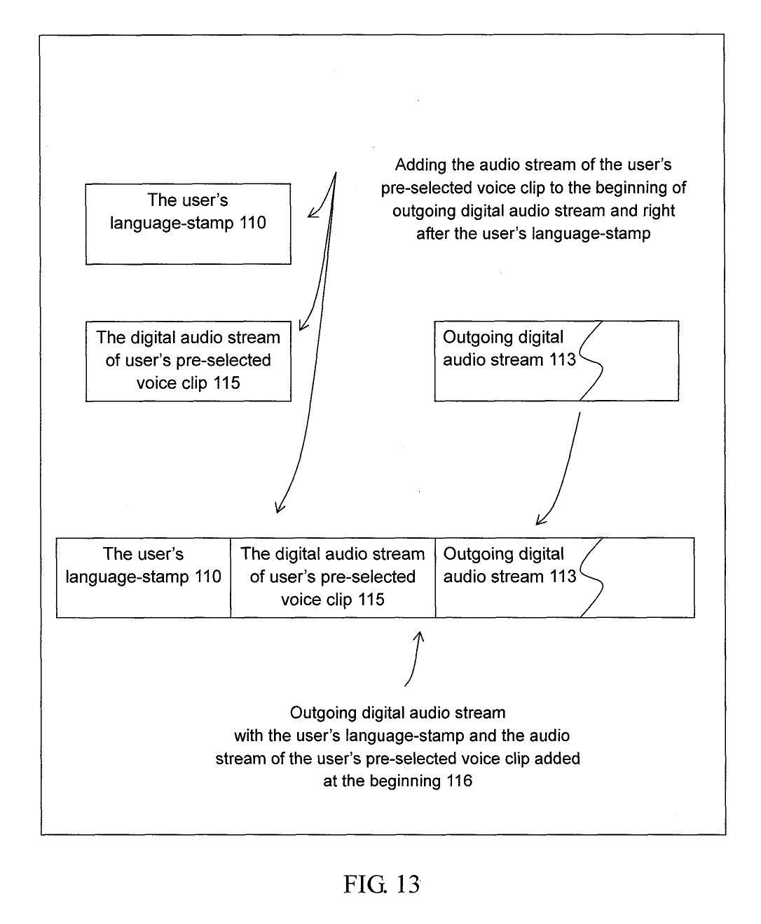

Referring to FIG. 13 of the drawings, the diagram of the process of the real time voice communication user terminal of the embodiment of the present invention is illustrated, accordingly, the real time voice communication user terminal 100 adds a digital audio stream of a user's pre-selected voice clip 115 to the beginning of the outgoing digital audio stream 113 and right after the user's language-stamp 110, before the outgoing digital audio stream 113 is transmitted to each of the connected communication user terminals 140 via the communication network 130 when the user's pre-selected voice clip 115 is pre-selected by the user, wherein the frequency of the voice clip is within the telephony voice band.

Accordingly, the user's designated language 112 is selected from the group consisting of the user's preferred language, the user's preset language and the real time voice communication user terminal's 100 system currently selected language.

Accordingly, the communication network 130 is selected from the group consisting of mobile communication network, telecommunication network, wireless telecommunication network, Internet, local area network, and wireless local area network.

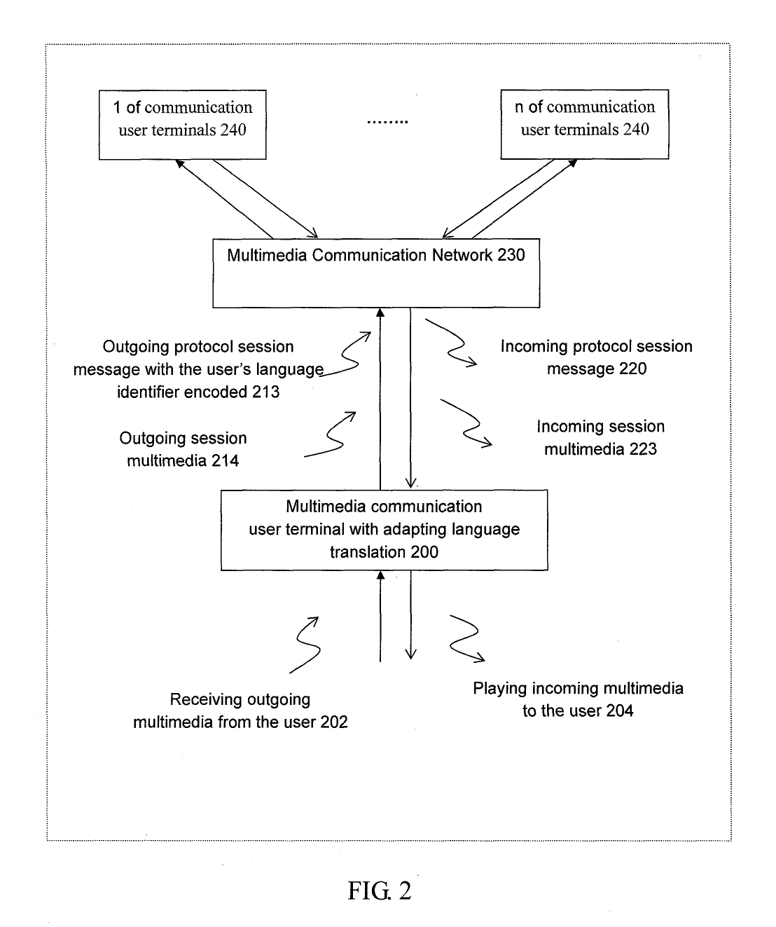

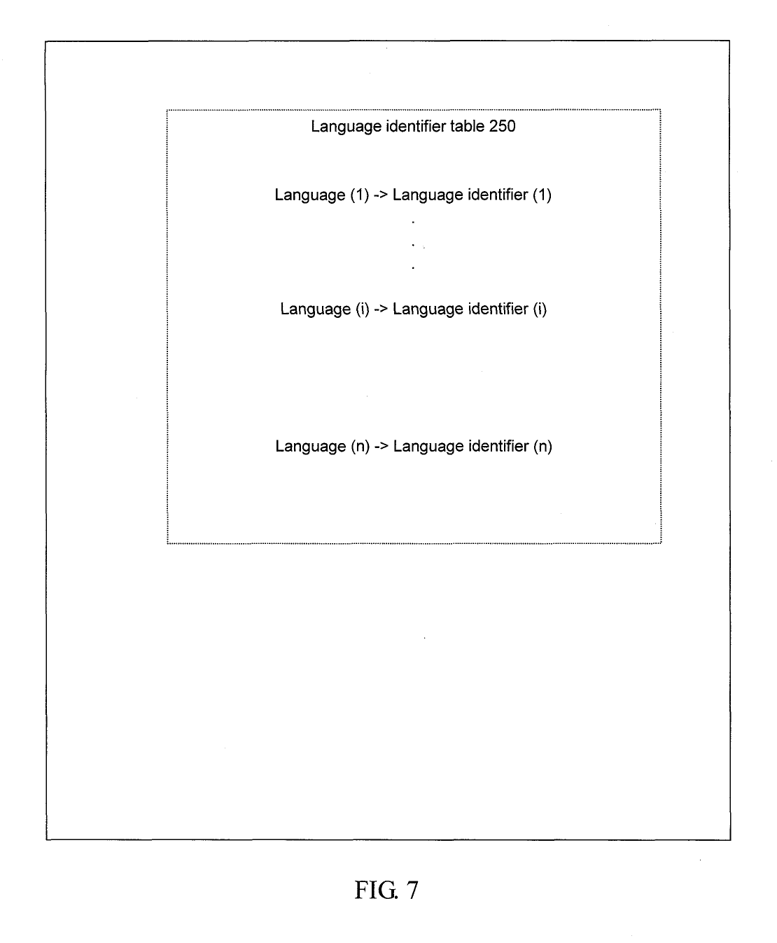

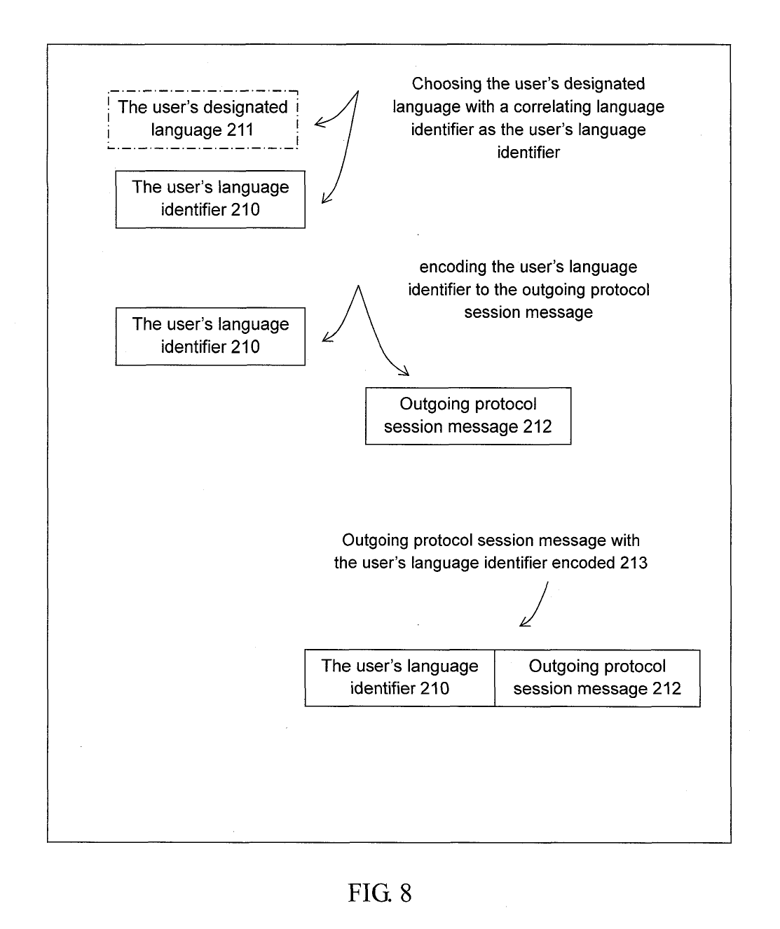

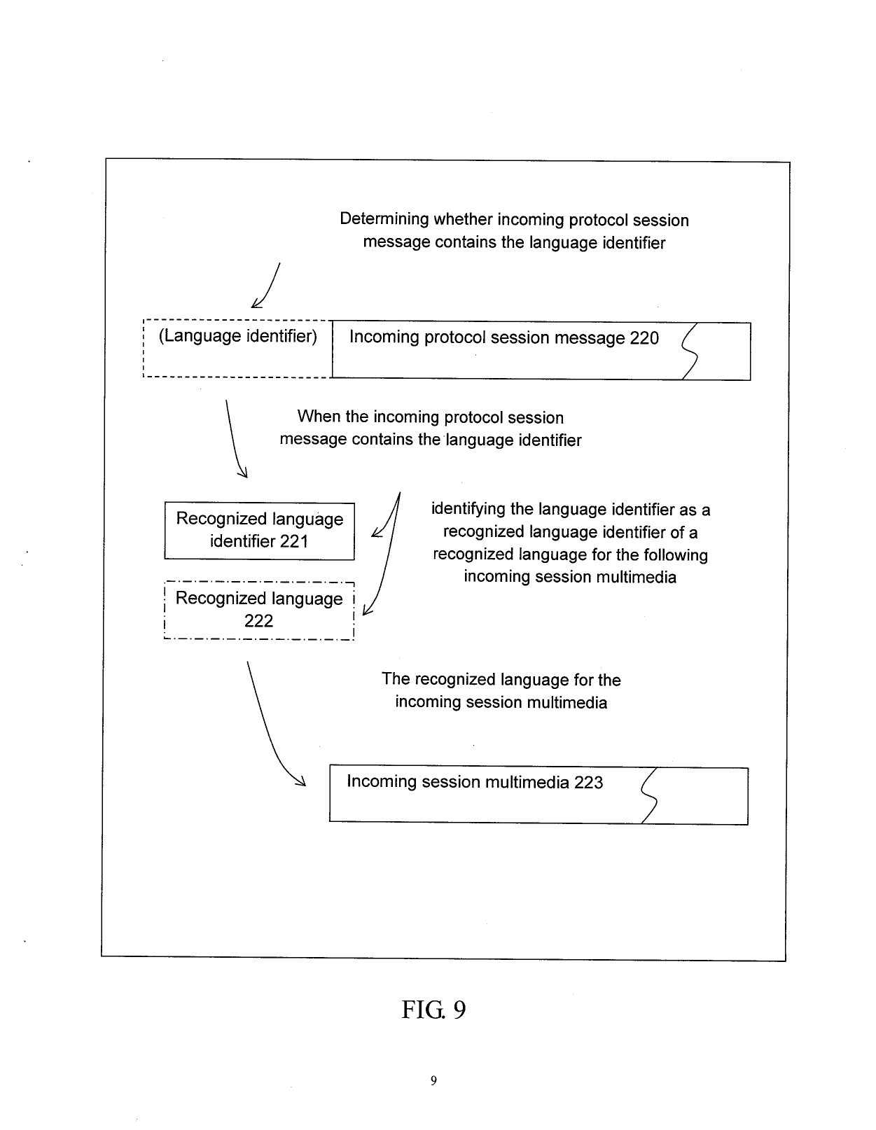

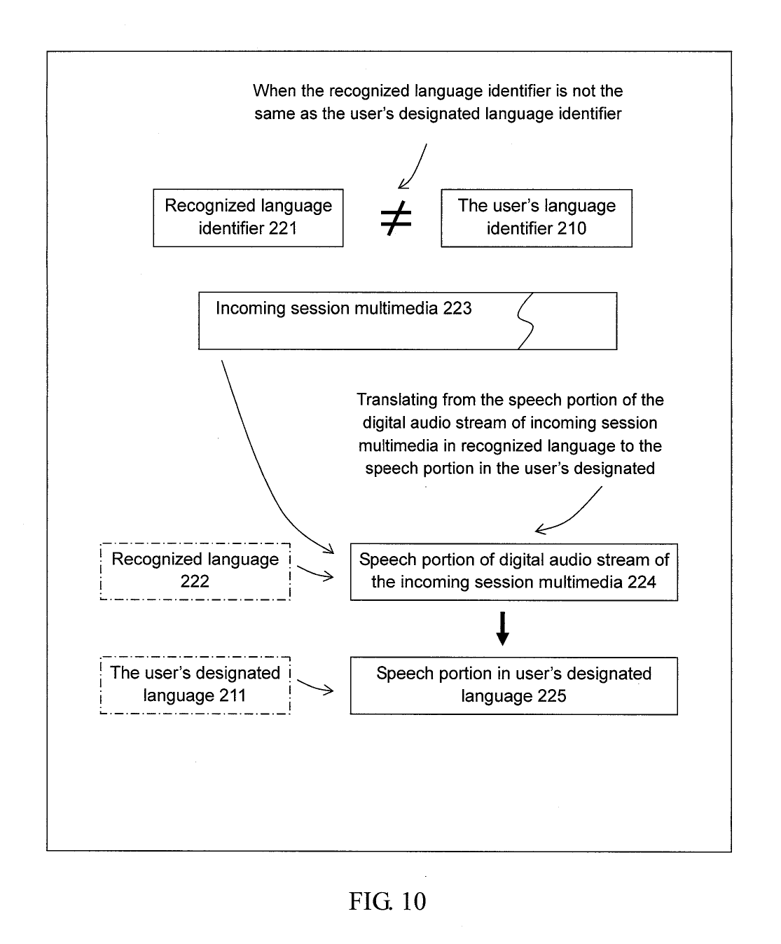

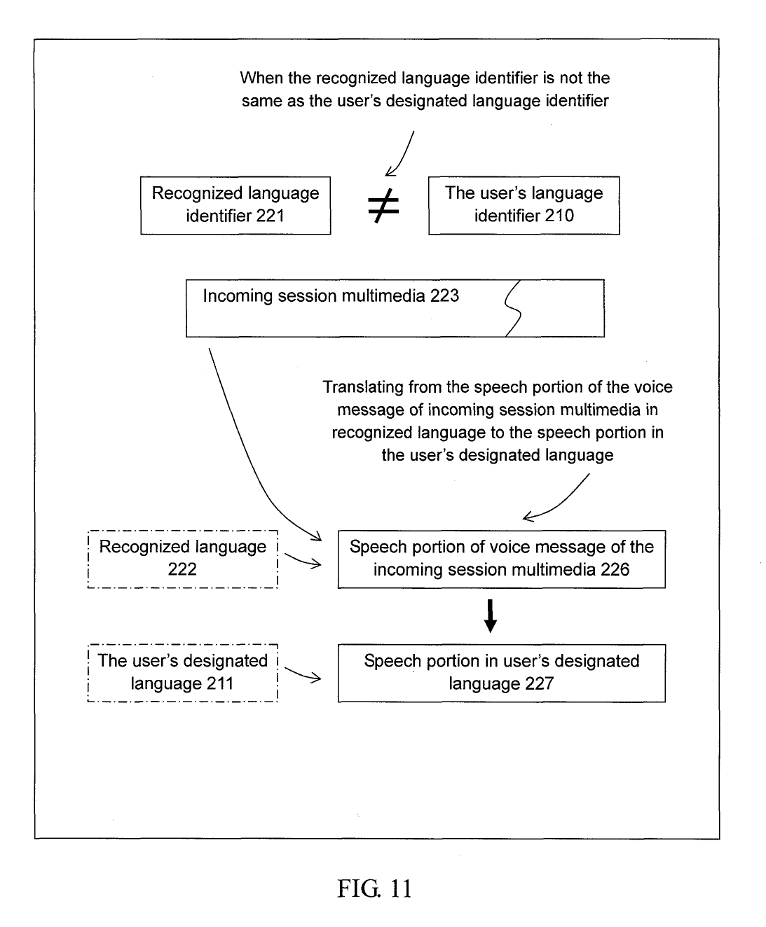

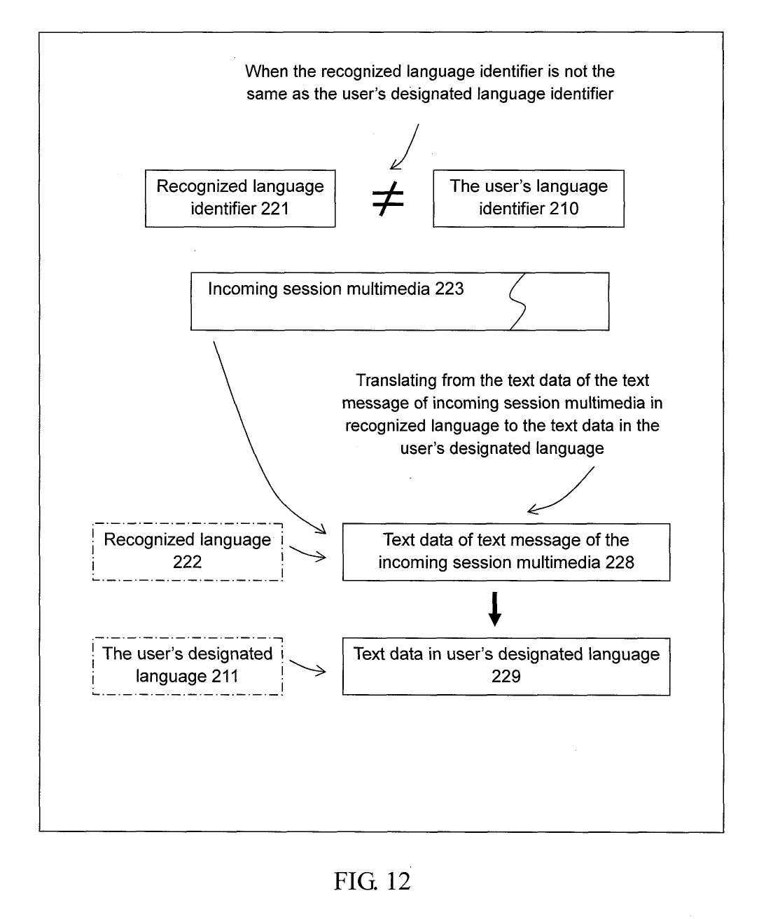

Referring to FIG. 2 of the drawings, an architectural diagram illustrating the multimedia communication user terminal with adapting language translation linking with a multimedia communication network to communicate with one or more communication user terminals, FIG. 7 of the drawings, a perspective view of language identifier table illustrating a specific language correlating to a specific language identifier, and FIG. 8 to FIG. 12 of the drawings, the diagram illustrating the process of the multimedia communication user terminal of the embodiment of the present invention, the multimedia communication user terminal 200 chooses user's designated language 211 that comes with a correlating language identifier as user's language identifier 210 from language identifier table 250, encodes the user's language identifier 210 into an outgoing protocol session message 212 before the outgoing protocol session message 212 is transmitted to a linked multimedia communication network 230, determines whether the incoming protocol session message 220 contains the language identifier, identifies the language identifier as the recognized language identifier 221 of the recognized language 222 for the following incoming session multimedia 223 when the incoming protocol session message 220 contains the language identifier, translates the speech portion of digital audio stream of the incoming session multimedia 224 in the recognized language 222 to the speech in the user's designated language 225 when the recognized language identifier 221 is not the same as the user's language identifier 210, translates speech portion of voice message of the incoming session multimedia 226 in the recognized language 222 to the speech in the user's designated language 227 when the recognized language identifier 221 is not the same as the user's language identifier 210, and translates text data portion of text message of the incoming session multimedia 228 in the recognized language 222 to the text data in the user's designated language 229 when the recognized language identifier 221 is not the same as the user's language identifier 210.

Accordingly, wherein the multimedia communication user terminal 200 provides one-to-multiple communication with a plurality of communication user terminals 240 via the multimedia communication network 230, wherein the multimedia communication user terminal 200 encodes the user's language identifier 210 into the outgoing protocol session message 212 before the outgoing protocol session message 212 is transmitted to each of the linked communication user terminals 240 via the multimedia communication network 230, wherein each of the communication user terminals 240 is selected from the group consisting of the multimedia communication user terminal 200 and another communication user terminal for multimedia communication, wherein, the multimedia communication user terminal 200 and each of the communication user terminals 240 is a cell phone, a smart phone, or a computer with multimedia communication features supported.

Accordingly, wherein the user's designated language 211 is selected from the group consisting of user's preferred language, user's preset language and the multimedia communication user terminal 200 of system currently selected language, wherein the language identifier is selected from the group consisting of a letter, letters, a number, numbers, ASCII code, and ASCII codes.

Accordingly, wherein the protocol session message is selected from the group consisting of telephony signaling protocols message, IP telephony protocols session message, and data communication control protocols message, wherein the session multimedia is selected from the group consisting of digital audio stream of voice, voice message, and text message.

Accordingly, wherein the multimedia communication network 230 is selected from the group consisting of mobile communication network, telecommunication network, wireless telecommunication network, Internet, local area network, and wireless local area network.

A method for implementing real time voice communication user terminal with adapting language translation for a user, comprising the steps of:

(a) choosing user's designated language 112 that comes with a correlating language-stamp as user's language-stamp 110 for user's language identifier 111;

(b) adding the user's language-stamp 110 to the beginning of outgoing digital audio stream 113 of user's outgoing voice 102;

(c) transmitting the outgoing digital audio stream with the user's language-stamp at the beginning 114 to a connected communication network 130;

(d) recognizing the language-stamp from the incoming digital audio stream 120;

(e) when the beginning of the incoming digital audio stream 120 contains the language-stamp 121, identifying the language-stamp 121 as the recognized language identifier 122 of the recognized language 123 for the incoming digital audio stream 120; and

(f) when the recognized language identifier 122 is not the same as the user's language identifier 111, translating from speech portion of the incoming digital audio stream 124 in the recognized language 123 to the speech in the user's designated language 125.

Accordingly, wherein, in step (c), when the real time voice communication user terminal 100 connects with a plurality of communication user terminals 140 via the communication network 130, transmitting the outgoing digital audio stream with the user's language-stamp at the beginning 114 to each of the connected communication user terminals 140 via the communication network 130, wherein each of the communication user terminals 140 is selected from the group consisting of the real time voice communication user terminal 100 and another communication user terminal for real time voice communication.

Accordingly, wherein, in step (b), adding a digital audio stream of a user's pre-selected voice clip 115 to the beginning of the outgoing digital audio stream 113 and right after the user's language-stamp 110 when the user's pre-selected voice clip 115 is pre-selected by the user, wherein the frequency of the voice clip is within the telephony voice band.

Accordingly, wherein, in step (a), a specific language correlates to a specific language-stamp, wherein the language-stamp comprises a digital audio stream of an audio clip such as a specific single- or multi-frequency tone clip, wherein the frequency of the audio is within the audio frequency band, wherein the user's designated language 112 is selected from the group consisting of user's preferred language, user's preset language and the user terminal of system currently selected language.

Accordingly, wherein, in step (c), the communication network 130 is selected from the group consisting of mobile communication network, telecommunication network, wireless telecommunication network, Internet, local area network, and wireless local area network.

A method for implementing multimedia communication user terminal with language-adaptation for a user, comprising the steps of:

(a) choosing user's designated language 211 that comes with a correlating language identifier as user's language identifier 210;

(b) encoding the user's language identifier 210 into an outgoing protocol session message 212;

(c) transmitting the outgoing protocol session message with the user's language identifier encoded 213 to a linked multimedia communication network 230;

(d) determining the language identifier from an incoming protocol session message 220;

(e) when the incoming session message 220 contains the language identifier, identifying the language identifier as a recognized language identifier 221 of a recognized language 222 for the following incoming session multimedia 223;

(f) when the recognized language identifier 221 is not the same as the user's language identifier 210, translating from speech portion of audio stream of the incoming session multimedia in the recognized language 224 to the speech in the user's designated language 225;

(g) when the recognized language identifier 221 is not the same as the user's language identifier 210, translating from speech portion of voice message of the incoming session multimedia in the recognized language 226 to the speech portion in the user's designated language 227; and

(h) when the recognized language identifier 221 is not the same as the user's language identifier 210, translating from text data portion of text message of the incoming session multimedia in the recognized language 228 to the text data portion in the user's designated language 229.

Accordingly, wherein, in step (c), when the multimedia communication user terminal 200 connects with a plurality of communication user terminals 240 via the linked the multimedia communication network 230, transmitting the outgoing protocol session message with the user's language identifier encoded 213 to each of the linked multimedia communication user terminals 240 via the multimedia communication network 230, wherein each of the multimedia communication user terminals 240 is selected from the group consisting of the multimedia communication user terminal 200 and another communication user terminal for multimedia communication.

Accordingly, wherein, in step (a), the language identifier is selected from the group consisting of a letter, letters, a number, numbers, ASCII code, and ASCII codes, wherein the user's designated language 211 is selected from the group consisting of user's preferred language, user's preset language and the multimedia communication user terminal 200 of system currently selected language.

Accordingly, wherein, in step (b), the protocol session message is selected from the group consisting of telephony signaling protocols message, IP telephony protocols session message, and data communication control protocols message, wherein the session multimedia is selected from the group consisting of digital audio stream of voice, voice message, and text message.

Accordingly, wherein, in step (c), wherein the multimedia communication network 230 is selected from the group consisting of mobile communication network, telecommunication network, wireless telecommunication network, Internet, local area network, and wireless local area network.

One skilled in the art will understand that the embodiment of the present invention as shown in the drawing and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A real time voice communication user terminal with adapting language translation for a user, comprising:
choosing user's designated language that comes with a correlating language-stamp as user's language-stamp for user's language identifier and adding said user's language-stamp to the beginning of outgoing digital audio stream of user's outgoing voice before said outgoing digital audio stream is transmitted to a connected communication network, wherein a specific language correlates to a specific said language-stamp, wherein said language-stamp comprises a digital audio stream of an audio clip, wherein the frequency of said audio is within the audio frequency band;
recognizing whether incoming digital audio stream contains said language-stamp, wherein when the beginning of said incoming digital audio stream contains said language-stamp, said real time voice communication user terminal identifies said language-stamp as a recognized language identifier of a recognized language for said incoming digital audio stream; and
translating from speech portion of said incoming digital audio stream in said recognized language to the speech in said user's designated language when said recognized language identifier is not the same as said user's language identifier.

2. The real time voice communication user terminal, as recited in claim 1, wherein said real time voice communication user terminal provides one-to-multiple real time voice communication with a plurality of communication user terminals via said communication network, wherein said real time voice communication user terminal adds said user's language-stamp to the beginning of said outgoing digital audio stream before said outgoing digital audio stream is transmitted to each of the connected said communication user terminals via said communication network, wherein each of said communication user terminals is selected from the group consisting of a said real time voice communication user terminal and another communication user terminal for real time voice communication.

3. The real time voice communication user terminal, as recited in claim 2, wherein said real time voice communication user terminal adds a digital audio stream of a user's pre-selected voice clip to the beginning of said outgoing digital audio stream and right after said user's language-stamp before said outgoing digital audio stream is transmitted to each of the connected said communication user terminals via said communication network when said user's pre-selected voice clip is pre-selected by said user, wherein the frequency of said voice clip is within the telephony voice band.

4. The real time voice communication user terminal, as recited in claim 2, wherein said user's designated language is selected from the group consisting of user's preferred language, user's preset language and said real time voice communication user terminal of system currently selected language.

5. The real time voice communication user terminal, as recited in claim 2, wherein said communication network is selected from the group consisting of mobile communication network, telecommunication network, wireless telecommunication network, Internet, local area network, and wireless local area network.

6. A multimedia communication user terminal with adapting language translation for a user, comprising:
choosing user's designated language that comes with a correlating language identifier as user's language identifier and encoding said user's language identifier into an outgoing protocol session message before said outgoing protocol session message is transmitted to a linked multimedia communication network;
determining whether an incoming protocol session message contains said language identifier, wherein when said incoming protocol session message contains said language identifier, said multimedia communication user terminal identifies said language identifier as a recognized language identifier of a recognized language for the following incoming session multimedia; and
translating from speech portion of digital audio stream of said incoming session multimedia in said recognized language to the speech in said user's designated language when said recognized language identifier is not the same as said user's language identifier, translating from speech portion of voice message of said incoming session multimedia in said recognized language to the speech in said user's designated language when said recognized language identifier is not the same as said user's language identifier, and translating from text data portion of text message of said incoming session multimedia in said recognized language to the text data in said user's designated language when said recognized language identifier is not the same as said user's language identifier.

7. The multimedia communication user terminal, as recited in claim 6, wherein said multimedia communication user terminal provides one-to-multiple multimedia communication with a plurality of communication user terminals via said multimedia communication network, wherein said multimedia communication user terminal encodes said user's language identifier into said outgoing protocol session message before said outgoing protocol session message is transmitted to each of linked said communication user terminals via said multimedia communication network, wherein each of said communication user terminals is selected from the group consisting of a said multimedia communication user terminal and another communication user terminal for multimedia communication.

8. The multimedia communication user terminal, as recited in claim 7, wherein said user's designated language is selected from the group consisting of user's preferred language, user's preset language and said multimedia communication user terminal of system currently selected language, wherein said language identifier is selected from the group consisting of a letter, letters, a number, numbers, ASCII code, and ASCII codes.

9. The multimedia communication user terminal, as recited in claim 7, wherein said protocol session message is selected from the group consisting of telephony signaling protocols message, IP telephony protocols session message, and data communication control protocols message, wherein said session multimedia is selected from the group consisting of digital audio stream of voice, voice message, and text message.

10. The multimedia communication user terminal, as recited in claim 7, wherein said multimedia communication network is selected from the group consisting of mobile communication network, telecommunication network, wireless telecommunication network, Internet, local area network, and wireless local area network.

11. A method for implementing real time voice communication user terminal with adapting language translation for a user, comprising the steps of:
(a) choosing user's designated language that comes with a correlating language-stamp as user's language-stamp for user's language identifier;
(b) adding said user's language-stamp to the beginning of outgoing digital audio stream of user's outgoing voice;
(c) transmitting said outgoing digital audio stream with said user's language-stamp added at the beginning to a connected communication network;
(d) recognizing said language-stamp from incoming digital audio stream;
(e) when the beginning of said incoming digital audio stream contains said language-stamp, identifying said language-stamp as a recognized language identifier of a recognized language for said incoming digital audio stream; and
(f) when said recognized language identifier is not the same as said user's language identifier, translating from speech portion of said incoming digital audio stream in said recognized language to the speech in said user's designated language.

12. The method, as recited in claim 11, wherein, in step (c), when said real time voice communication user terminal connects with a plurality of communication user terminals via said communication network, transmitting said outgoing digital audio stream with said user's language-stamp added at the beginning to each of the connected said communication user terminals via said communication network, wherein each of said communication user terminals is selected from the group consisting of a said real time voice communication user terminal and another communication user terminal for real time voice communication.

13. The method, as recited in claim 12, wherein, in step (b), adding a digital audio stream of a user's pre-selected voice clip to the beginning of said outgoing digital audio stream and right after said user's language-stamp when said user's pre-selected voice clip is pre-selected by said user, wherein the frequency of said voice clip is within the telephony voice band.

14. The method, as recited in claim 12, wherein, in step (a), a specific language correlates to a specific said language-stamp, wherein said language-stamp comprises a digital audio stream of an audio clip, wherein the frequency of said audio is within the audio frequency band, wherein said user's designated language is selected from the group consisting of user's preferred language, user's preset language and said user terminal of system currently selected language.

15. The method, as recited in claim 12, wherein, in step (c), said communication network is selected from the group consisting of mobile communication network, telecommunication network, wireless telecommunication network, Internet, local area network, and wireless local area network.

16. A method for implementing multimedia communication user terminal with adapting language translation for a user, comprising the steps of:
(a) choosing user's designated language that comes with a correlating language identifier as user's language identifier;
(b) encoding said user's language identifier into an outgoing protocol session message;
(c) transmitting said outgoing protocol session message with said user's language identifier encoded to a linked multimedia communication network;
(d) determining said language identifier from an incoming protocol session message;
(e) when said incoming session message contains said language identifier, identifying said language identifier as a recognized language identifier of a recognized language for the following incoming session multimedia;
(f) when said recognized language identifier is not the same as said user's language identifier, translating from speech portion of audio stream of said incoming session multimedia in said recognized language to said speech in said user's designated language;
(g) when said recognized language identifier is not the same as said user's language identifier, translating from speech portion of voice message of said incoming session multimedia in said recognized language to said speech portion in said user's designated language; and
(h) when said recognized language identifier is not the same as said user's language identifier, translating from text data portion of text message of said incoming session multimedia in said recognized language to said text data portion in said user's designated language.

17. The method, as recited in claim 16, wherein, in step (c), when said multimedia communication user terminal communicates with a plurality of communication user terminals via said multimedia communication network, transmitting said outgoing protocol session message with said user's language identifier encoded to each of linked said multimedia communication user terminals via said multimedia communication network, wherein each of said communication user terminals is selected from the group consisting of a said multimedia communication user terminal and another communication user terminal for multimedia communication.

18. The method, as recited in claim 17, wherein, in step (a), said language identifier is selected from the group consisting of a letter, letters, a number, numbers, ASCII code, and ASCII codes, wherein said user's designated language is selected from the group consisting of user's preferred language, user's preset language and said multimedia communication user terminal of system currently selected language.

19. The method, as recited in claim 17, wherein, in step (b), said protocol session message is selected from the group consisting of telephony signaling protocols message, IP telephony protocols session message, and data communication control protocols message, wherein said session multimedia is selected from the group consisting of digital audio stream of voice, voice message, and text message.

20. The method, as recited in claim 17, wherein, in step (c), wherein said multimedia communication network is selected from the group consisting of mobile communication network, telecommunication network, wireless telecommunication network, Internet, local area network, and wireless local area network.
